(19) United States
(12) Patent Application Publication
(10) Pub. No.: US 2026/0277731 A1
(43) Pub. Date: Sep. 17, 2026

(54) AUTONOMOUS FAILURE RESPONSE FOR ENHANCED COMPUTE CLUSTER RESILIENCE AND EFFICIENCY

(71) Applicant: NVIDIA Corporation, Santa Clara, CA (US)

(72) Inventors: Dong Ahn, San Ramon, CA (US); Maer Rodrigues de Melo, Los Angeles, CA (US); Ning Xu, Bothell, WA (US); Ruoxi Zhang, Santa Clara, CA (US); Aleksandr Shaposhnikov, Camas, WA (US); Kumar Anik, Redmond, WA (US); Pallab Bhattacharya, San Jose, CA (US)

(21) Appl. No.: 19/080,001

(22) Filed: Mar. 14, 2025

(51) Int. Cl. G06F 11/07; G06T 1/20

(52) U.S. Cl. CPC G06F 11/0793; G06F 11/0721; G06F 11/079; G06T 1/20

(57) ABSTRACT

Systems and methods for autonomous failure response to enhance compute cluster resilience and efficiency. The systems and methods are suitable, e.g., for enhancing resilience and efficiency of computational workflows, e.g., deep learning/AI model training jobs, performed, e.g., via GPU-accelerated supercomputers. According to one or more embodiments, systems and methods obtain both application-level and hardware/infrastructure level health data associated with a workflow and implement, following the detection of a fault in the workflow, automated interventions, e.g. updating the workflow for a restart, for fault remediation.

### FIELD

The present disclosure relates to enhancing resilience and efficiency of computational workflows, e.g., deep learning/AI model training jobs, performed, e.g., via GPU-accelerated supercomputers. According to one or more embodiments, systems and methods obtain both application-level and hardware/infrastructure-level health data associated with a workflow to implement interventions for fault remediation.

### BACKGROUND

The complexity of massive AI training jobs in cloud-based data center environments is staggering. These jobs often involve processing enormous datasets, sometimes in the petabyte range, using intricate neural network architectures that can contain billions of parameters. The computational demands are immense, requiring the orchestration of thousands of high-performance GPUs or specialized AI accelerators working in parallel. This distributed computing approach necessitates sophisticated job scheduling, efficient data pipelines, and robust networking infrastructure to manage the flow of information between nodes. Moreover, these training jobs must contend with challenges such as load balancing, fault tolerance, and optimizing resource allocation across a heterogeneous hardware landscape. The software stack supporting these operations is equally complex, incorporating advanced frameworks, custom libraries, and monitoring tools to ensure the training process remains stable and efficient over weeks or even months of continuous computation.

Despite the advanced technologies and methodologies employed, massive AI training jobs are not immune to failures. When these jobs crash, the consequences can be severe, potentially resulting in the loss of days or weeks of progress and significant financial costs due to wasted compute resources. Restarting such jobs is not always straightforward, as it requires careful consideration of checkpointing strategies, data consistency, and the potential need for hyperparameter adjustments. The impact of job failures extends beyond immediate resource waste; it can delay critical research timelines, affect product development cycles, and even influence strategic decisions within organizations relying on the AI models being trained.

Furthermore, frequent crashes can strain the overall data center infrastructure, potentially affecting other concurrent jobs and services. To mitigate these risks, teams must invest heavily in robust error handling, automated recovery mechanisms, and comprehensive logging systems to facilitate rapid diagnosis and resolution of issues when they arise.

### BRIEF DESCRIPTION OF THE DRAWINGS

Subject matter of the present disclosure is described in detail below with reference to the attached drawing figures. Features described and/or illustrated herein can be used alone and/or combined in different combinations. The attached drawings illustrate the following:

FIG. 1 is a flow diagram illustrating a method for providing resilience and enhancing productivity, e.g., of a deep learning/AI model training workflow, in accordance with an embodiment;

FIG. 2 is a functional block diagram illustrating a system for providing resilience and enhancing productivity of compute-intensive operations, e.g., deep learning/AI model training, in accordance with an embodiment;

FIG. 3 is a block diagram illustrating a service for providing resilience and enhancing productivity, in accordance with an embodiment;

FIG. 4 is a conceptual diagram of a processing system implemented using a PPU, suitable for use in implementing some embodiments of the present disclosure;

FIG. 5A illustrates an exemplary system in which the various architecture and/or functionality of the various previous embodiments may be implemented;

FIG. 5B illustrates components of an exemplary system that can be used to train and utilize machine learning, in at least one embodiment; and

FIG. 6 illustrates an exemplary streaming system suitable for use in implementing some embodiments of the present disclosure.

### DETAILED DESCRIPTION

The present disclosure provides systems and methods for autonomous failure response for enhancing compute cluster resilience and efficiency. The systems and methods are suitable, e.g., for enhancing resilience and efficiency of machine learning operations (MLOps), e.g., deep learning/AI model training jobs, performed, e.g., via GPU-accelerated supercomputers. According to one or more embodiments, systems and methods integrate a wide array of components involved in the AI model training lifecycle into a unified, automated system focused on downtime reduction. According to one or more embodiments, systems and methods offer core services specifically tailored to automate both manual and non-manual recovery processes. According to one or more embodiments, systems and methods are able to autonomously handle most failures of an AI workflow and initiate immediate recovery without the need for input from model engineers. As a result, one or more embodiments not only boost productivity but also enable successful AI training practices to be scaled across current and future generations of AI data center supercomputers.

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles, semi-autonomous vehicles (e.g., in one or more advanced driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training or updating, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations, systems implemented using large language models (LLMs), systems implemented using vision language models (VLMs), systems for performing light transport simulation, systems for performing collaborative content creation for 3D assets, systems implemented at least partially using cloud computing resources, and/or other types of systems.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications-such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

According to one or more embodiments, a system for monitoring computational workflows (in particular, compute-heavy workflow such as deep learning/AI model training jobs) on computing clusters is provided. The system includes interfaces for obtaining both (i) application-level health data (e.g., application logs and metrics) and (ii) hardware/infrastructure-level health data (e.g., Syslog message logs and system metrics); a fault detection and analysis engine configured to (i) detect a fault (e.g., an anomaly or failure), and (ii) correlate both application-level and hardware/infrastructure-level health data associated with the fault; and an auto-resume policy engine, configured to (i) classify the fault, based on the correlated health data, as being (1) application-level, (2) hardware/infrastructure-level, or (3) ambiguous; and (ii) execute an intervention, based on the classification of the fault.

According to one or more embodiments, a system for monitoring computational workflows (e.g., deep learning/AI model training jobs) on computing clusters includes an auto-resume policy engine that, based on both (i) a prior intervention by an auto-resume policy engine in the form of a restart and (ii) detection of a further anomaly/fault, executes a further intervention based on both (A) the classification of the further anomaly/fault and (B) the characteristics of the prior intervention.

According to one or more embodiments, a system for monitoring computational workflows (e.g., deep learning/AI model training jobs) on computing clusters includes an auto-resume policy engine that is configured to execute an intervention, selected based on a fault being classified as ambiguous, designed to disambiguate the fault classification. In one or more embodiments, disambiguation of ambiguous-classification faults is accomplished through a sequence of targeted interventions, e.g., shuffling allocation of a workflow to a different set of GPUs (e.g., that does not include one or more GPUs previously involved in the workflow but flagged for isolation or otherwise indicated as being potentially problematic), thereby disambiguating the fault (by eliminating said one or more GPUs previously involved in the workflow as a source of the fault).

According to one or more embodiments, a method for monitoring computational workflows (e.g., deep learning/AI model training jobs) on computing clusters includes obtaining both (i) application-level health data (e.g., application logs and metrics) and (ii) hardware/infrastructure-level health data (Syslog message logs and system metrics); detecting a fault; correlating both application-level and hardware/infrastructure-level health data associated with the anomaly/fault; classifying the fault, based on the correlated health data, as being (1) application-level, (2) hardware/infrastructure-level, or (3) ambiguous; and executing an intervention, based on the classification of the anomaly/fault.

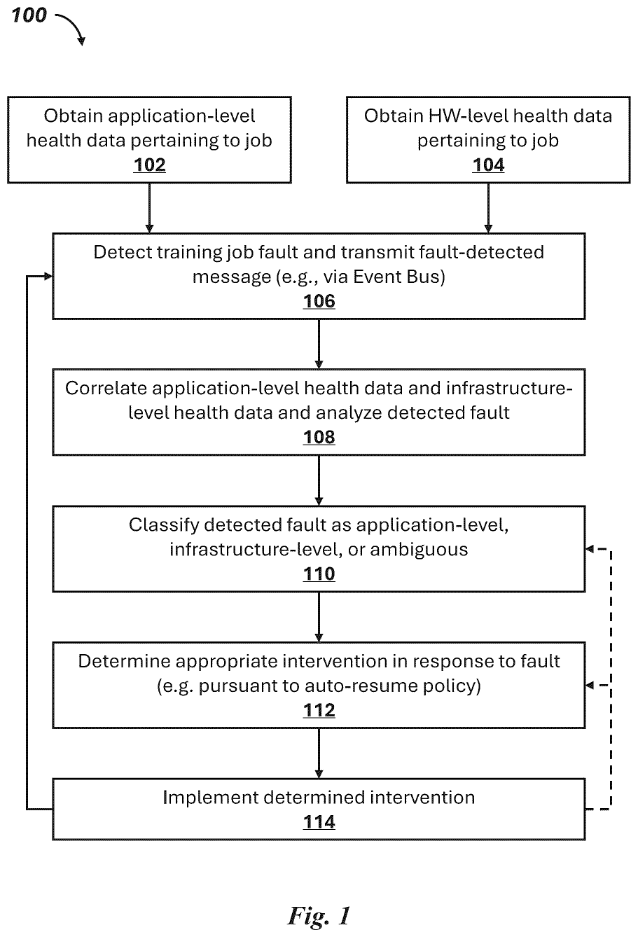

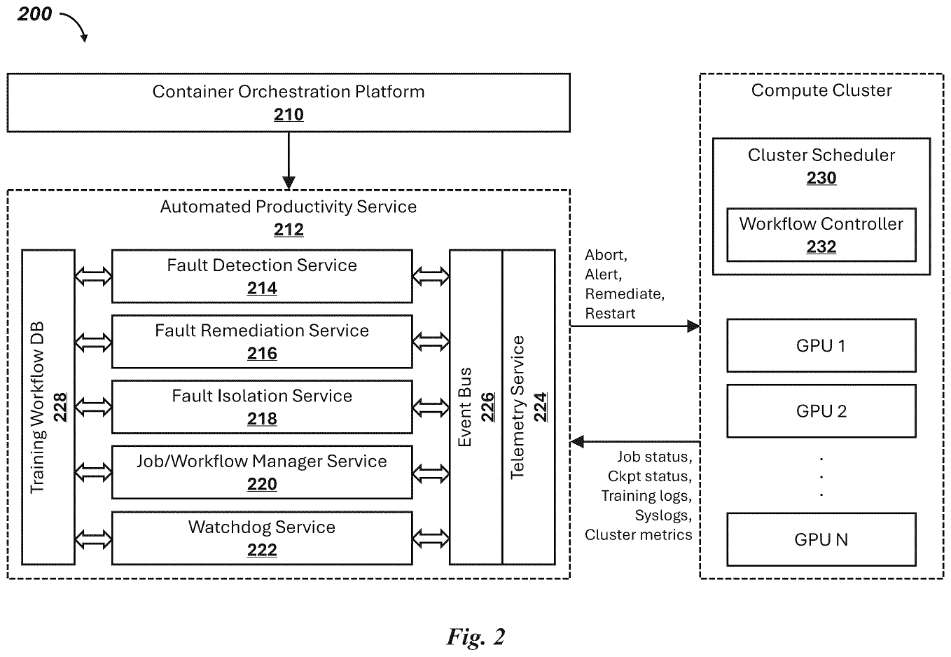

FIG. 1 is a flow diagram illustrating a method 100 for providing resilience and enhancing productivity, i.e., of a large-scale deep learning/AI model training job/workflow, in accordance with an embodiment. Each block of method 100, described herein, comprises a computing process that may be performed using any combination of hardware, firmware, and/or software. For instance, various functions may be carried out by a processor executing instructions stored in memory. Method 100 may also be embodied as computer-usable instructions stored on computer storage media. Method 100 may be provided by a standalone application, a service or hosted service (standalone or in combination with another hosted service), or a plug-in to another product, to name a few. In addition, method 100 is described, by way of example, with respect to the system of FIG. 2. However, this method may additionally or alternatively be executed by any one system, or any combination of systems, including, but not limited to, those described herein. Furthermore, persons of ordinary skill in the art will understand that any system that performs method 100 is within the scope and spirit of embodiments of the present disclosure.

At 102 and 104, method 100 obtains application-level and hardware/infrastructure-level health data, respectively, pertaining to the deep learning/AI model training job. In one or more embodiments, the health data pertaining to the training job is obtained via continuous collection by a telemetry service and includes, e.g., training application logs (e.g., Python-level exceptions and error outputs from the communications layer (NCCL and UB)) and system logs and (e.g., syslogs (mlxcheckers, nvrmchecker (e.g., Xid, nvswitch), lustrechecker (e.g., Lnet down), mlxchecker (e.g., host link down)) and metrics (e.g., Data Center GPU Manager (DGCM) metrics and host network metrics). In one or more embodiments, the health data can include error indicators, e.g., “NaN” (Not a Number) in an application log, indicating, e.g., an issue with data processing, input validation, or calculation logic in the application. In one or more embodiments, the health data can identify least performing nodes, e.g., from straggler detectors.

In one or more embodiments, the telemetry service utilized by method 100 provides for rapid collection of health signals, thereby facilitating rapid detection of and response to failures and minimization of downtime. In one or more embodiments, the telemetry service includes a metrics-based monitoring and alerting system and a log aggregation system. In one or more embodiments, the telemetry service utilized by method 100 is telemetry service 224 of system 200 of FIG. 2.

At 106, method 100 detects a failure of the deep learning/AI model training job and transmits a failure-detected message, e.g., via an event bus. In one or more embodiments, the failure is detected by a fault detection engine (e.g., a workflow engine/microservice) configured to monitor application log records obtained at 102 (e.g., via a log telemetry system) and at 104 (e.g., via the log telemetry system and a metrics-based monitoring and alerting system). A “failure” can be detected from any of an application crash, a progress stall (e.g., a code hang manifested in communication libraries (e.g. PyTorch NVIDIA Collective Communications Library (NCCL) watchdog errors and communication hangs) or in the absence of an output line in the log), or a throughput drop (e.g., manifested in training throughput (TFLOP), and can be transient or persistent). Once the “failure” is detected, a failure-detected message is transmitted via an event bus to notify downstream services.

In one or more embodiments, method 100 utilizes an anomaly detection/watcher service designed to detect symptoms of a job failure for detecting the failure at 106. In one or more embodiments, the anomaly detection/watcher service is configured to periodically poll query endpoints of a telemetry system to obtain application-level health data (i.e., the application-level health data obtained at 102) and hardware/infrastructure-level health data (i.e., the hardware/infrastructure level health data obtained at 104). In one or more embodiments, the anomaly detection/watcher service is configured to rapidly detect a job failure (e.g., within 25 seconds of a polling cycle), thereby facilitating rapid detection of and response to failures and minimization of downtime. In one or more embodiments, the anomaly detection/watcher service utilized by method 100 is fault detection service 214 of system 200 of FIG. 2.

At 108, method 100 correlates application-level and hardware infrastructure-level health data (obtained at 102 and 104) with the failure (detected at 106) and analyzes the failure. In one or more embodiments, analysis of the failure includes retrieving detailed job and fault information (e.g., from a job/workflow manager), analyzing telemetry health data, running various checkers on system logs, application logs and network metrics. In at least one embodiment, analysis of the failure includes identifying nodes directly responsible for job failures, categorizing them accordingly, and marking isolated nodes for exclusion from future restarts. At 110, method 100 classifies the failure, e.g., as hardware infrastructure-level, application-level, or ambiguous. In one or more embodiments, method 100 takes into account, at 110, prior interventions (and the details thereof) selected to remediate previously detected failures. For example, if a previously detected failure was classified as ambiguous, a prior intervention was taken to shuffle the set of nodes used to execute the training job, and the subsequent failure (i.e., the failure detected at 106) persists, then method 100 may determine that a failure that would otherwise be classified as “ambiguous” should instead be classified as “application-level.”

At 112, method 100 determines an appropriate intervention (e.g. strategy for resuming the deep learning/AI model training job that has failed) in response to the failure (detected at 106). In one or more embodiments, the appropriate intervention can be one or more of implementing a node exclusion policy for a known bad node, a node shuffle policy for ambiguous failures, or issuing a notification, via a user interface (UI), to a user in the event of a failure. In addition, method 112 may also take into account, at 112, prior interventions (and the details thereof) selected to remediate previously detected failures. In one or more embodiments, the appropriate intervention is determined in accordance with an auto-resume policy. At 114, method 100 implements the determined intervention. In one or more embodiments, the appropriate intervention is one or more of: implementing a node exclusion policy for a known bad node (i.e., an example of a hardware-level failure) or implementing a node shuffle policy for an ambiguous failure.

In one or more embodiments, method 100 may, at 110 and/or 112, consult a data model, to which training workflow events and updates are mapped, in order to account for prior faults and/or interventions and to determine an appropriate intervention to make in response to a currently detected fault. For example, method 100 may, at 110 and/or 112, determine an update for a training job (e.g., specifying a different set of nodes to implement a shuffling policy) based on consultation of both (i) the data model to which previous training workflow events and updates are mapped and (ii) the correlated application-level and hardware infrastructure-level health data corresponding to the fault detected at 106.

In one or more embodiments, method 100 utilizes various components of an automated productivity service (e.g., automated productivity service 212 of FIG. 2) to analyze and classify the failure at 108 and 110 and to determine an appropriate intervention and to intervene at 112 and 114. In one or more embodiments, a fault remediation service (e.g., fault remediation service 216) is configured to initiate a predefined action for each distinct failure type. For example, a check-and-kill action signals a training application in a stalled state before terminating the job. In one or more embodiments, an anomaly isolation service (e.g., fault isolation service 218) is configured to run and collect application-level diagnostics (e.g., collection of application stack traces) and system-level diagnostics (e.g., Slurm epilog health checks) to narrow down a vastly large search space and isolate a failure to a few unhealthy nodes or infrastructure components with highly accurate failure attribution. The fault remediation service can use health data from the terminated job (as well as from previous jobs) to update the next job/job restart so as to exclude isolated (problematic) nodes before releasing the job for restart—thereby ensuring that only healthy nodes that have passed anomaly isolation checks.

FIG. 2 is a functional block diagram illustrating a system 200 for providing resilience and enhancing productivity of machine learning operations, e.g., deep learning/AI model training jobs, performed via GPU-accelerated supercomputers, in accordance with an embodiment. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of system 200 is within the scope and spirit of embodiments of the present disclosure.

System 200 includes an automated productivity service (APS) 212 orchestrated by a container orchestration platform 210. APS 212 includes a set of microservices including an fault detection service 214, a fault remediation service 216, an fault isolation service 218, and a job/workflow manager service 220, and a watchdog service 222. In addition, APS includes a telemetry service 224, an event bus 226, and a training workflow database 228. A workflow controller 232 is additionally provided that runs on the monitored system itself (e.g., the GPU-accelerated supercomputer carrying out a deep learning/AI model training job). In one or more embodiments, the microservices of APS 212 communicate with one another through event bus 224 and/or Representational State Transfer (REST) Application Programming Interfaces (APIs). In one or more embodiments, the container orchestration platform 210 is Kubernetes. APS 212 provides resilience and enhances productivity by integrating a variety of components involved in the AI training lifecycle into a unified, automated flow focused on downtime optimization. APS 212 is configured to autonomously handle most failures in the AI workflow and initiate immediate recovery (e.g., by implementing, collectively by the various microservices, an auto-resume policy) without the need for input from AI model engineers.

Key capabilities of APS 212 include real-time application fault (e.g., anomaly/failure) detection, e.g. by monitoring training application logs to detect anomalous conditions currently experienced by an application (e.g., application hangs, performance drops and stragglers, and crashes). Key capabilities of APS 212 further include identifying the causes of the symptom promptly, isolating the failure down to specific infrastructure components, such as a malfunctioning GPU or an intermittent interconnect issue on a node, or storage errors (e.g., excessive retries of a Luster/S3 IO request). Following isolation, capabilities of APS 212 include alerting a user, and perhaps more importantly, taking remedial action, e.g., updating subsequent jobs to exclude faulty nodes and automatically restarting them.

Fault detection service 214 is configured to monitor application-level and hardware/infrastructure-level health data and detect anomalies/failures in a job/workflow, e.g., a deep learning/AI model training job performed by a GPU-accelerated supercomputer. In one or more embodiments, fault detection service 214 is a workflow engine designed to monitor a set of anomaly patterns in training application log records obtained via a log telemetry system (e.g., via a Loki server) and notify downstream services if an anomalous application health issue or failure is detected. In one or more embodiments, fault detection service 214 monitors one or more of: job throughput (e.g., training job throughput in TFLOP), processing time (in seconds, e.g., time spent processing events for all detection workflows), total job event observed (by job identifier (e.g., “job_id”), the number of training jobs observed), and executor runs (the number of executions of detection workflows).

In one or more embodiments, fault detection service 214 detects anomalous application health issues by performing a sequence of steps in a directed acyclic graph (DAG), in which each step has specific dependencies, such as executing a telemetry query every 15 seconds before passing the result of this query into a health predicate in order to evaluate the current health state of training. In one or more embodiments, fault detection service 214 can support detection steps of varying degrees of complexity. A simple workflow might only involve performing a log query in the telemetry system and sending a fault-detected message to the event bus if the query result matches an anomaly pattern. A complex workflow might pass the query results to update an application health model state, e.g., a persistent performance drop can be detected by continuously updating a moving average of model floating point utilization (MFU) of the training job.

Fault remediation service 216 is configured to receive a notification of an anomalous application health issue or failure provided by fault detection service 214 and take remedial action. In one or more embodiments, fault remediation service 216 is a stateless microservice specifically designed to react to a fault-detected message sent, e.g., from an anomaly detector/watcher service. In one or more embodiments, fault remediation service 216 is configured to signal and/or terminate jobs, e.g., training jobs that have stalled or are experiencing a persistent performance drop. In one or more embodiments, fault remediation service 216 is configured to transmit messages that trigger downstream services (e.g., bad node isolation analysis on anomalous jobs), helping to identify and isolate nodes that may be causing problems. In one or more embodiments, fault remediation service 216 is configured to update a next job to exclude an isolated and/or problematic node(s) before releasing that job for automatic restart. In one or more embodiments, fault remediation service 216 functions as an integrative coordinator that connects fault detection service 214 with other core services, e.g., fault isolation service 218, job/workflow manager service 220, etc. In one or more embodiments, fault remediation service 216, by coordinating actions across different services, facilitates a cohesive and efficient response to anomalies.

Fault isolation service 218 is configured to be activated by fault remediation service 216 and to correlate application-level and hardware/infrastructure-level health data corresponding to the anomalous application health issue or failure, analyze the anomalous application health issue or failure, and diagnose the anomalous application health issue or failure. In one or more embodiments, fault isolation service 218 is a microservice configured to attribute a failure and isolate the failure to an infrastructure component where it originated (e.g., an unhealthy node). In one or more embodiments, fault isolation service 218 is activated by fault remediation service 216. In one or more embodiments, upon activation, fault isolation service 218 is configured to retrieve detailed job and anomaly information from a job/workflow manager and then proceed to perform telemetry health data analysis, running various checkers on system logs, application logs, and network metrics. In one or more embodiments, fault isolation service 218 is configured to identify nodes directly responsible for job failures and categorize them accordingly, e.g., as “isolated,” marking them for exclusion from future restarts. In contrast, non-isolated nodes, which have experienced errors likely caused by application issues rather than node failures, are not excluded from future restarts. In one or more embodiments, however, fault isolation service 218 may classify such non-isolated nodes to assist users with understanding a failure. In one or more embodiments, fault isolation service 218 sends its isolation decisions and non-isolated node information via event bus 224, and the isolation decisions and non-isolated node information can be consumed, e.g., by fault remediation service 216 and/or job/workflow manager service 220, to take further action based thereupon.

Job/workflow manager service 220 is configured to manage data persistence pertaining to training lifecycle and make persisted data available for consumption by other services or end users. In one or more embodiments, job/workflow manager service 220 receives training workflow events that include anomalies, checkpoints, and job status updates sent, e.g., from anomaly detector/watcher and a workflow controller service via the event bus. In one or more embodiments, job/workflow manager service 220 maps training workflow events and updates, which can be, e.g., ephemeral in nature, to a workflow data model and persists said events and updates into a back-end data store, i.e., training workflow database 228. In one or more embodiments, data model is separated from the underlying back-end data store to facilitate swapping in and out of different back-end data stores. In one or more embodiments, job/workflow manager service 220 exposes REST endpoints that allow other services and users access training workflow event and failure-related information.

Watchdog service 222 is an optional service configured to run alongside a workflow controller service 232 (that runs, e.g., on a GPU-accelerated supercomputer itself) and to ensure that a failure in APS 212 does not result in a complete lack of training progress. In one or more embodiments, watchdog service 222 is configured to release a next job in queue with an unmodified configuration if APS 212 fails to identify and/or remediate a training job failure within a configurable timeout.

Workflow controller 232 is a service that runs on the system being monitored by APS 212 (e.g., a GPU-accelerated supercomputer on which AI training workflow scheduled by cluster scheduler 230 is being run). Workflow controller 232 directly interfaces with the workflow manager system, e.g. Simple Linux Utility for Resource Management (Slurm). In one or more embodiments, workflow controller 232 is responsible for publishing job states to event bus 232 and thence to the other components of APS 212 and for executing certain actions on the training cluster on behalf of other components of APS 212. This includes workflow-specific tasks like terminating and releasing jobs as well as signaling the jobs to activate in-application checks (e.g., straggler and lightweight stack trace analysis). In one or more embodiments, workflow controller 232 is embodied as a system service run on a dedicated CPU node in the training cluster.

Telemetry service 224 provides for rapid collection of health signals, thereby facilitating rapid detection of and response to failures and minimization of downtime. In one or more embodiments, telemetry service 224 include a metrics-based monitoring and alerting system and a log aggregation system. In one or more embodiments, the metrics-based monitoring and alerting system and the log aggregation system are optimized to work alongside one another.

In one or more embodiments, the metrics-based monitoring and alerting system of telemetry service 224 provides one or more of: (i) time-series data collection and storage, (ii) multi-dimensional data model using metrics and labels, (iii) a query language built for data analysis, (iv) built-in alerting capabilities, (v) independent server nodes for high reliability, and (vi) a pull-based model for scraping metrics from instrumented applications. In one or more embodiments, the telemetry systems include the Prometheus metrics-based monitoring and alerting system.

In one or more embodiments, the metrics-based monitoring and alerting system includes a server configured to ingest system metrics from GPU nodes, label the ingested metrics, and to serve the labeled metrics to other components of a system for providing resilience and enhancing productivity. In one or more embodiments, the system metrics are provided by GPU node exporters, e.g., a node-exporter (for providing hardware and OS metrics exposed by *NIX kernels) and a DCGM exporter (for providing GPU metrics exposed by NVIDIA DCGM). In one or more embodiments, the ingested system metrics are labeled with an identifier of the GPU node from which the system metrics originated and/or the GPU cluster from which the system metrics originated. In one or more embodiments, the server is a Prometheus server.

In one or more embodiments, the log aggregation system of telemetry service 224 provides one or more of: (i) specialized log collection, storage, and querying, (ii) a push-based model for log ingestion, (iii) a log-specific query language, (iv) cost-effective, long-term log retention, (v) labels-based indexing for efficient log stream identification, and (vi) native integration with a metrics-based monitoring and alerting system. In one or more embodiments, the telemetry systems include the Loki log aggregation system.

In one or more embodiments, the log aggregation system includes a log aggregation server configured to ingest syslog messages from all GPU nodes and label the ingested syslog messages, e.g., with an identifier of the GPU node from which the syslog message originated. In one or more embodiments, the log aggregation system includes a server configured to ingest application-level logs from a workload manager and job scheduling system. In one or more embodiments, the workload manager and job scheduling system is the Simple Linux Utility for Resource Management (Slurm). In one or more embodiments, the log aggregation server is a Loki server.

Event Bus 226 provides a central communication hub between the various microservices of APS 212. In one or more embodiments, event bus 226 is a publish-subscribe system that supports multiple publishers and consumers for each event type. The publish-subscribe system enables multiple consumers (e.g., microservices of APS 212) to subscribe to a specific event or event type, decoupling components and improving scalability. In one or more embodiments, event bus 226 provides a fanout exchange that ensures that every message published to an exchange is forwarded to all bound queues. In one or more embodiments, event bus 226 employs a single producer, multiple consumer model in which each event type has a designated producer, ensuring controlled message generation, and in which multiple services can subscribe to and consume specific events, enhancing system responsiveness and fault tolerance. In one or more embodiments, event bus 226 supports both manual and automatic acknowledgement mechanisms for reliable message delivery. In one or more embodiments, event bus 226 leverages dead-letter exchanges and message expiration for enhanced control and error handling.

In one or more embodiments, event bus 226 plays a pivotal role in orchestrating interactions between different components of APS 212 and the jobs/workflows it is configured to monitor. In one or more embodiments, for example: workflow controller 232 monitors jobs/workflows and sends job and node updates to event bus 226; job/workflow manager service 220 listens for “job updates” messages and persists the current state of the jobs (e.g., to training workflow database 228); fault detection service 214 watches for telemetry data from telemetry service 224, detects error logs, and sends a fault-detected message to event bus 226 to initiate fault (e.g., anomaly/failure) processing; fault remediation service 216 listens to an fault-detected event from fault detection service 214, kills a running job as a result, and publishes a “job killed” event when it sends a kill command to cluster scheduler 230; fault isolation service 218 consumes “job killed” events to initiate fault isolation processes and publishes an “isolation result” event after completing the processing of a fault.

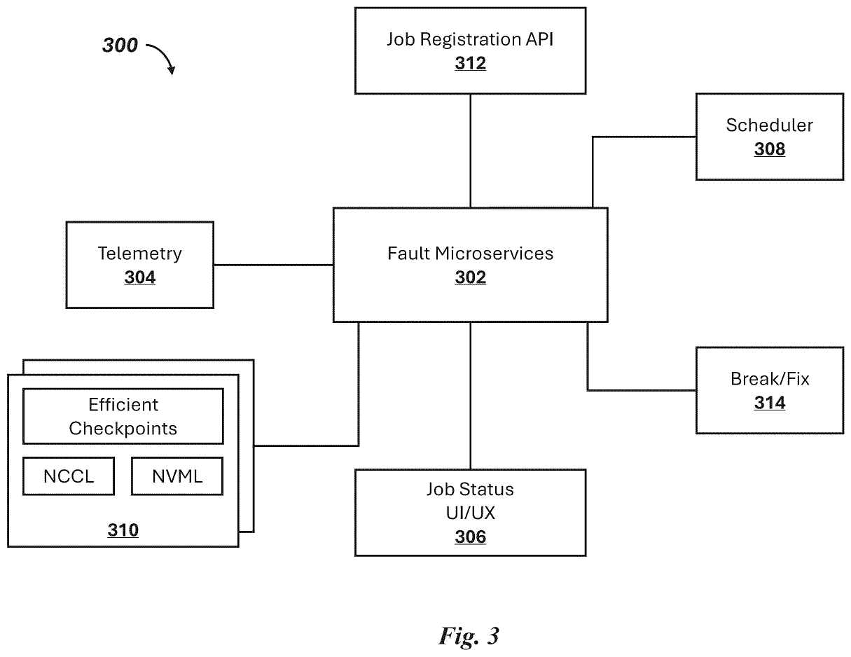

FIG. 3 is a block diagram illustrating a service 300 for providing resilience and enhancing productivity of machine learning operations, e.g., deep learning/AI model training jobs, in accordance with an embodiment. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the service 300 is within the scope and spirit of embodiments of the present disclosure.

The service 300 provides a cloud-native, end-to-end approach for automated productivity enhancement, integrating (i) a set of microservices (e.g., orchestrated by a container orchestration platform) configured to manage large-scale jobs/workflows (e.g., a deep learning/AI model training job) with (ii) infrastructure services (e.g., telemetry services and health checks) and (iii) software resiliency packages for improving fault tolerance and efficiency in AI and machine learning tasks.

Service 300 includes fault microservices 302, a telemetry system 304, a job status UI/UX 306, a scheduler 308, a break/fix service 310, a job registration API 312, and software resiliency packages for improving fault tolerance and efficiency in AI and machine learning tasks. In one or more embodiments, the fault microservices 302 include one or more (e.g., all) of fault detection service 214, fault remediation service 216, fault isolation service 218, job/workflow manager service 220, and watchdog service 222 of system 200 of FIG. 2. Fault microservices 302 are integrated with telemetry system 304 (e.g., telemetry service 224 of system 200 of FIG. 2) and scheduler 308. In one or more embodiments, scheduler 308 is a workload manager and job scheduling system, e.g. Slurm or Run: AI (an AI orchestration and GPU virtualization platform designed to optimize the utilization of GPU resources for AI workloads).

In one or more embodiments, fault microservices 302 (which can be, e.g., the microservices of APS 212 of FIG. 2) provide a fault detection and analysis engine, comprising one or more of the aforementioned set of microservices, configured to detect a fault (e.g., an anomaly or failure), and correlate both application-level and hardware/infrastructure-level health data associated with the fault. In one or more embodiments APS 212 provides an auto-resume policy engine, comprising one or more of the aforementioned set of microservices, configured to classify the fault, based on the correlated health data, as being application-level, hardware/infrastructure-level, or ambiguous, and execute an intervention based on the classification of the fault. In one or more embodiments, the auto-resume policy engine is configured to, based on both a prior intervention by the auto-resume policy engine in the form of a restart and detection of a further anomaly/fault, execute a further intervention based on both the classification of the further anomaly/fault and the characteristics of the prior intervention. In one or more embodiments, the auto-resume policy engine is configured to execute an intervention, selected based on a fault being classified as ambiguous, designed to disambiguate the fault classification. In one or more embodiments, disambiguation of ambiguous-classification faults is accomplished through a sequence of targeted interventions.

Fault microservices 302 are also integrated with software resiliency packages 314, which provide an asynchronous checkpoint library, a collective communications library, and a management library. In one or more embodiments, the asynchronous checkpoint library provides for asynchronous checkpointing to minimize downtime. In one or more embodiments, a static checkpoint interval recommendation is provided as \sqrt{2×Tₛₐᵥₑ×MTTI}, where Tₛₐᵥₑ is a checkpoint save overhead and MTTI is the mean time to interruption. As Tₛₐᵥₑ decreases, checkpointing can be carried out more frequently, reducing downtime due to lost work. In one or more embodiments, the collective communications library is the NVIDIA collective communications library (NCCL), designed to optimize multi-GPU communication in AI training scenarios. In one or more embodiments, the management library is the NVIDIA management library (NVML), which provides a programmatic interface for monitoring and managing various states within GPUs, allowing real-time tracking of GPU utilization, monitoring of processing running on a GPU, error management queries, and performance optimization (e.g., by enabling control over power limits and thermal thresholds allowing for fine-tuning of GPU performance during model training).

Fault microservices 302 are additionally integrated with a job status UI/UX 306, which allows, e.g., notification of a job failure to be provided to an AI model error, along with various data related to the failure. Furthermore, fault microservices 302 are integrated with break/fix service 310 and job registration API 312, enabling fault microservices to trigger actions related to remediation (e.g., restarting a job) and isolation of a fault (e.g., anomaly/job failure).

More illustrative information will now be set forth regarding various optional architectures and features with which the foregoing systems and methods may be implemented, in accordance with embodiments. It should be strongly noted that the following information is set forth for illustrative purposes and should not be construed as limiting in any manner. Any of the following features may be optionally incorporated with or without the exclusion of other features described.

### EXEMPLARY COMPUTING SYSTEM

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

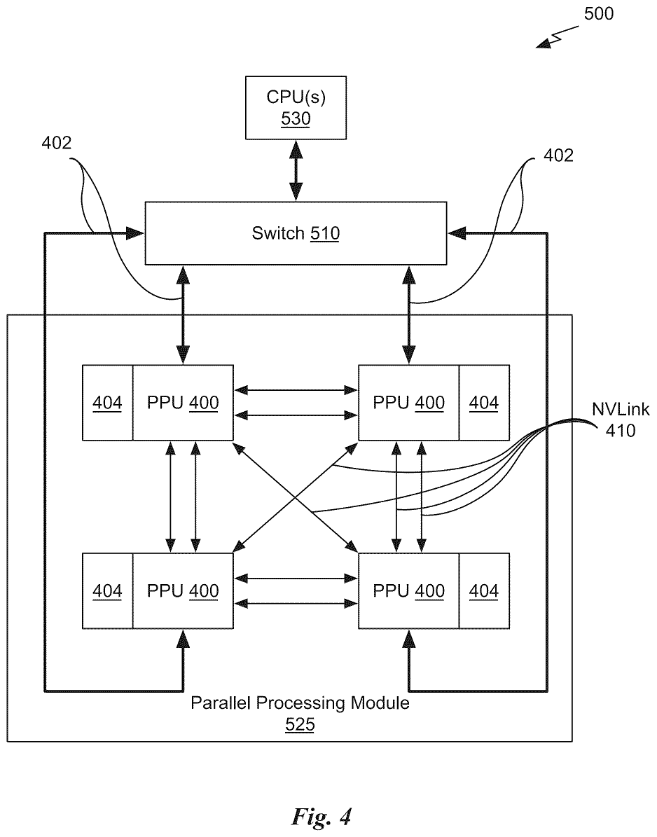

FIG. 4 is a conceptual diagram of a processing system 500 implemented using multiple PPUs 400, in accordance with an embodiment. The exemplary system 500 may utilized as a particular node—or portion thereof—in the above-described multi-node computing systems. In addition to the multiple PPUs 400, the processing system 500 includes a CPU 530, switch 510, and respective memories 404 for the PPUs 400.

Each parallel processing unit (PPU) 400 may include hundreds or thousands of cores that are capable of handling hundreds or thousands of software threads simultaneously. The PPUs 400 may generate pixel data for output images in response to rendering commands (e.g., rendering commands from the CPU(s) 530 received via a host interface). The PPUs 400 may include graphics memory, such as display memory, for storing pixel data or any other suitable data, such as GPU data. The display memory may be included as part of the memory 404. The PPUs 400 may include two or more GPUs operating in parallel (e.g., via a link). The link may directly connect the GPUs (e.g., using NVLINK 410) or may connect the GPUs through a switch (e.g., using switch 510). When combined together, each PPU 400 may generate pixel data or GPGPU data for different portions of an output or for different outputs (e.g., a first PPU for a first image and a second PPU for a second image). Each PPU 400 may include its own memory 404, or may share memory with other PPUs 400.

The PPUs 400 may each include, and/or be configured to perform functions of, one or more processing cores and/or components thereof, such as Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMS), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The NVLink 410 provides high-speed communication links between each of the PPUs 400. Although a particular number of NVLink 410 and interconnect 402 connections are illustrated in FIG. 4, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 4, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 4, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

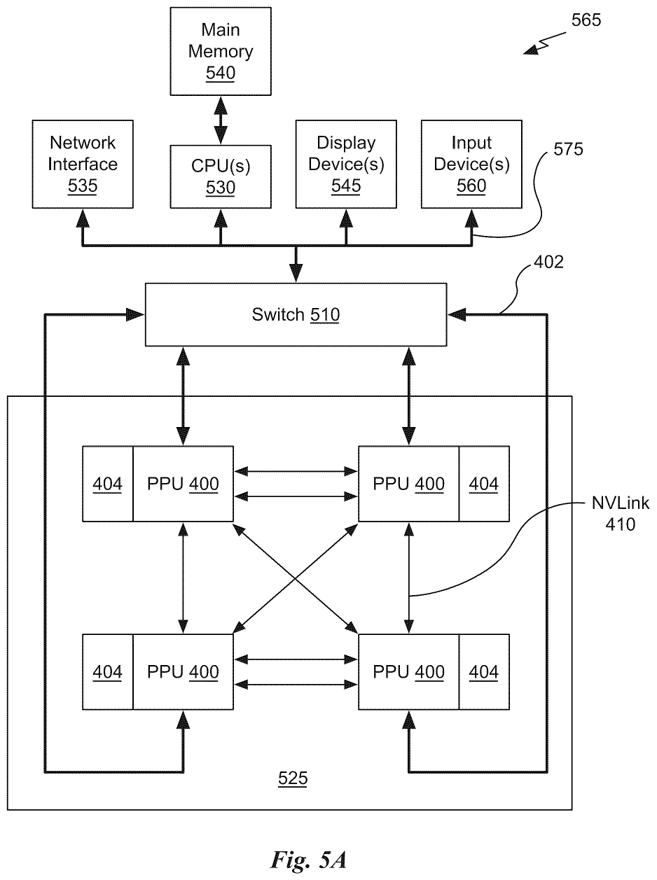

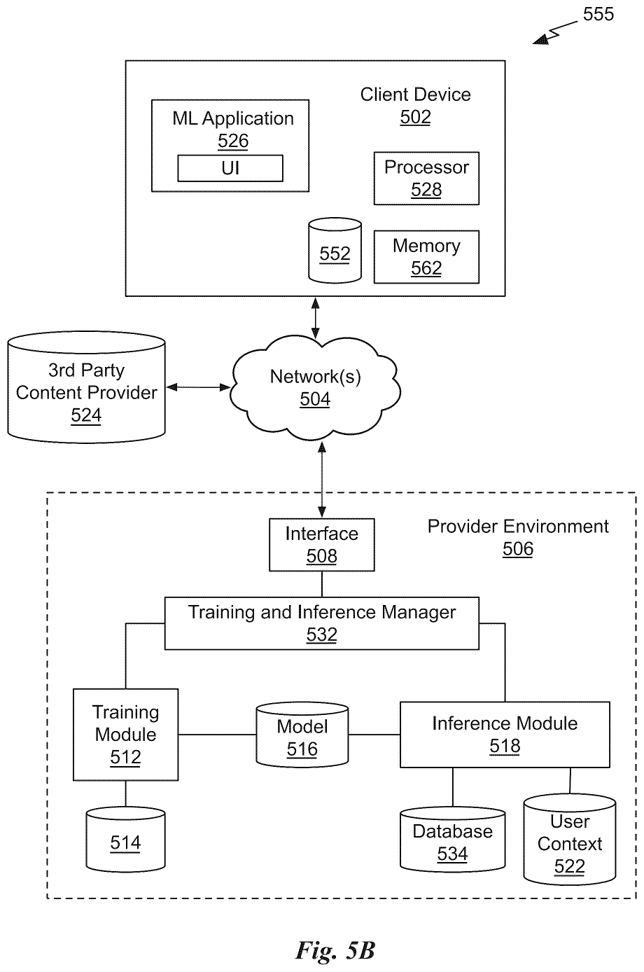

FIG. 5A illustrates an exemplary system 565 in which the various architecture and/or functionality of the various previous embodiments may be implemented. The exemplary system 565 may be configured to implement the method 300 shown in FIG. 3.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5A are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5A is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5A.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system.

Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition.

Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### EXAMPLE NETWORK ENVIRONMENTS

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 4 and/or exemplary system 565 of FIG. 5A—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments-in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 4 and/or exemplary system 565 of FIG. 5A. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### MACHINE LEARNING

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., neurons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting.

Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5B illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506. In at least one embodiment, supervised and/or unsupervised training can be performed by the client device 502 and/or the provider environment 506. In at least one embodiment, a set of training data 514 (e.g., classified or labeled data) is provided as input to function as training data.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### GRAPHICS PROCESSING PIPELINE

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### EXAMPLE STREAMING SYSTEM

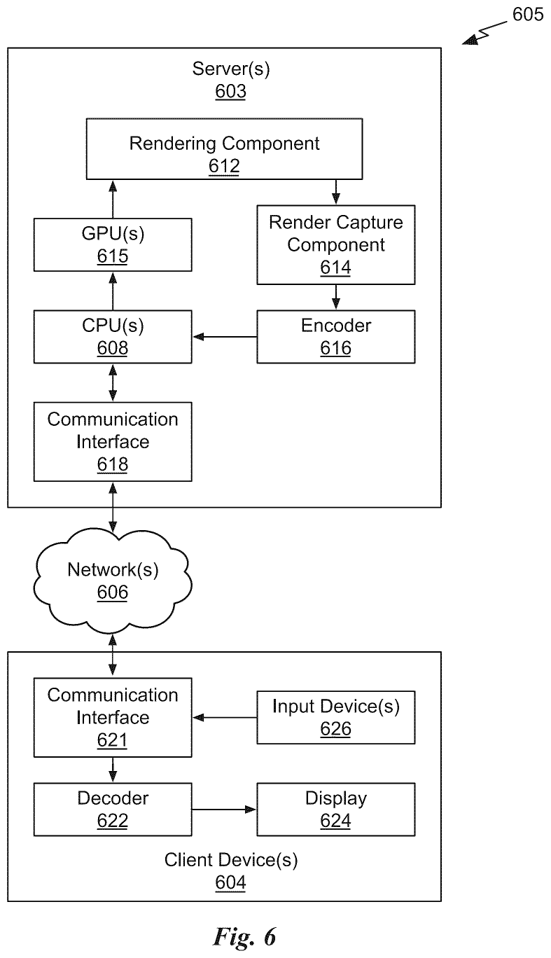

FIG. 6 is an example system diagram for a streaming system 605, in accordance with some embodiments of the present disclosure. FIG. 6 includes server(s) 603 (which may include similar components, features, and/or functionality to the example processing system 500 of FIG. 4 and/or exemplary system 565 of FIG. 5A), client device(s) 604 (which may include similar components, features, and/or functionality to the example processing system 500 of FIG. 4 and/or exemplary system 565 of FIG. 5A), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

The arrangement of components illustrated in the attached Figures are for illustrative purposes and that other arrangements are possible. For example, one or more of the elements described herein may be realized, in whole or in part, as an electronic hardware component.

Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. Various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

1. A computer-implemented method for monitoring a computational workflow on a computing cluster, the method comprising:
obtaining application-level health data pertaining to the computational workflow;
obtaining infrastructure-level health data pertaining to the computational workflow;
detecting, based on the application-level health data and/or the infrastructure-level health data, a fault;
after detecting the fault, correlating the application-level health data and the infrastructure-level health data to provide correlated application-and infrastructure-level health data;
classifying, based on the correlated application-and infrastructure-level health data, the fault as being one of: application-level, infrastructure-level, or ambiguous;
determining, based on the classification of the fault, an intervention; and
executing the intervention.

2. The computer-implemented method of claim 1, wherein the fault is a subsequently detected fault, and wherein the executing the intervention is further based on a prior intervention selected to remediate a previously detected fault.

3. The computer implemented method of claim 2, wherein the previously detected fault is classified as ambiguous, and wherein the prior intervention is an intervention selected to disambiguate the previously detected fault.

4. The computer implemented method of claim 3, wherein the prior intervention comprises shuffling a set of graphics processing units (GPUs) assigned to the computational workflow.

5. The computer implemented method of claim 4, wherein the intervention determined based on the classification of the fault comprises isolating a GPU assigned to the computational workflow or providing a notification to a user of an application error.

6. (canceled)

7. The computer implemented method of claim 1, wherein the detecting the fault comprises detecting any one or more of: an application crash, a progress stall, or a throughput drop.

8. The computer implemented method of claim 7, wherein the detecting the fault comprises detecting the progress stall by a code hang manifested in a communication library or by an absence of an output line in an application log.

9. The computer implemented method of claim 1, wherein the computing cluster is:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative operations using a large language model (LLM);
a system for performing generative operations using a vision language model (VLM);
a system for performing generative operations using a multi-modal language model;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a collaborative content creation platform for 3D assets;
a system implemented at least partially using cloud computing resources;
a system using or deploying one or more inference microservices; or a system that incorporates one or more machine learning models deployed in a service or microservice along with an OS-level virtualization package (e.g., a container).

10. A system for monitoring a computational workflow on a computing cluster, the system comprising:
one or more processor-readable memories; and
one or more processors configured to carry out processor executable instructions stored on the one or more processor-readable memories to:
obtain application-level health data pertaining to the computational workflow;
obtain infrastructure-level health data pertaining to the computational workflow;
detect, based on the application-level health data and/or the infrastructure-level health data, a fault;
after detecting the fault, correlate the application-level health data and the infrastructure-level health data to provide correlated application-and infrastructure-level health data;
classify, based on the correlated application-and infrastructure-level health data, the fault as being one of: application-level, infrastructure-level, or ambiguous;
determine, based on the classification of the fault, an intervention; and
execute the intervention.

11. The system of claim 10, wherein the fault is a subsequently detected fault, and wherein the executing the intervention is further based on a prior intervention selected to remediate a previously detected fault.

12. The system of claim 11, wherein the previously detected fault is classified as ambiguous, and wherein the prior intervention is an intervention selected to disambiguate the previously detected fault.

13. The system of claim 12, wherein the prior intervention comprises shuffling a set of graphics processing units (GPUs) assigned to the computational workflow.

14. The system of claim 13, wherein the intervention determined based on the classification of the fault comprises isolating a GPU assigned to the computational workflow or providing a notification to a user of an application error.

15. The system of claim 10, wherein the one or more processors are configured to implement a service comprising a fault detection microservice, a fault isolation microservice, and a fault remediation microservice,
wherein the fault detection microservice is configured to perform the obtaining the application-level health data, the obtaining the infrastructure-level health data, and the detecting, based on the application-level health data and/or the infrastructure-level health data, the fault;
wherein the fault isolation microservice is configured to perform the classifying, based on the correlated application-and infrastructure-level health data, the fault; and
wherein the fault remediation microservice is configured to perform the determining, based on the classification of the fault, the intervention and to perform the executing the intervention.

16. The system of claim 15, the service further comprising workflow manager service configured to manage data persistence pertaining to training lifecycle.

17. The system of claim 16, the service further comprising an event bus configured to implement a publish-subscribe system for inter-microservice communication.

18. The system of claim 11, wherein the computing cluster is:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative operations using a large language model (LLM);
a system for performing generative operations using a vision language model (VLM);
a system for performing generative operations using a multi-modal language model;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a collaborative content creation platform for 3D assets;
a system implemented at least partially using cloud computing resources;
a system using or deploying one or more inference microservices; or a system that incorporates one or more machine learning models deployed in a service or microservice along with an OS-level virtualization package (e.g., a container).

19. A non-transitory computer readable medium having stored thereon processor executable instructions that, when executed by one or more processors, cause the one or more processors to perform a method for monitoring a computational workflow on a computing cluster, the method comprising:
obtaining application-level health data pertaining to the computational workflow;
obtaining infrastructure-level health data pertaining to the computational workflow;
detecting, based on the application-level health data and/or the infrastructure-level health data, a fault;
after detecting the fault, correlating the application-level health data and the infrastructure-level health data to provide correlated application-and infrastructure-level health data;
classifying, based on the correlated application-and infrastructure-level health data, corresponding the fault as being one of: application-level, infrastructure-level, or ambiguous;
determining, based on the classification of the fault, an intervention; and
executing the intervention.

20. The non-transitory computer readable medium according to claim 19, wherein the computing cluster is:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative operations using a large language model (LLM);
a system for performing generative operations using a vision language model (VLM);
a system for performing generative operations using a multi-modal language model;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a collaborative content creation platform for 3D assets;
a system implemented at least partially using cloud computing resources;
a system using or deploying one or more inference microservices; or a system that incorporates one or more machine learning models deployed in a service or microservice along with an OS-level virtualization package (e.g., a container).

21. A system for monitoring a computational workflow on a computing cluster, the system comprising:
one or more processor-readable memories; and
one or more processors configured to carry out processor executable instructions stored on the one or more processor-readable memories to implement a service comprising a fault detection microservice, a fault isolation microservice, and a fault remediation microservice, wherein:
the fault detection microservice is configured to:
obtain application-level health data pertaining to the computational workflow,
obtain infrastructure-level health data pertaining to the computational workflow, and
detect, based on the application-level health data and/or the infrastructure-level health data, a fault;
the fault isolation microservice is configured to:
classify, based on application-level health data corresponding to the fault and/or infrastructure-level health data corresponding to the fault, the fault as being one of: application-level, infrastructure-level, or ambiguous; and
the fault remediation microservice is configured to:
determine, based on the classification of the fault, an intervention, and execute the intervention.
